(19) United States
(12) Patent Application Publication
(10) Pub. No.: US 2005/0202138 A1
(43) Pub. Date: Sep. 15, 2005

(54) Apparatus, a system and a method for collecting drips from a frozen treat

(76) Inventor: Valerie Kazich, Darien, IL (US)

Correspondence Address: PATENTS+TMS, P.C., 2849 W. ARMITAGE AVE., CHICAGO, IL, 60647, US

(21) Appl. No.: 10/800,225

(22) Filed: Mar. 12, 2004

(51) Int. Cl. A23G 1/00

(52) U.S. Cl. 426/421

(57) ABSTRACT

An apparatus, a system and a method collects drips from a frozen treat on a stick or a double-stick frozen treat having a tray with a cover on a side of the tray. The stick of the frozen treat has a handle or two sticks of the double-stick frozen treat have two handles which extends outside of the frozen treat. The cover is made from an absorbent material. Further, the tray has an opening which receives the handle of the stick or handles of the double-stick frozen treat. The handle or two handles are inserted into the opening until the cover abuts the frozen treat. Still further, the opening allows the stick or the two sticks of the frozen treat to be held in an upright position above the cover. Moreover, the cover collects the drips from the frozen treat and/or absorbs the drips from the frozen treat. The opening prevents the drips from the frozen treat from flowing down the handle of the stick or two handles of the double-stick frozen treat. Furthermore, the tray prevents the collected drips from spilling onto a user and/or surroundings of the user.

### BACKGROUND OF THE INVENTION

The present invention generally relates to an apparatus and a system and a method used during consumption of a frozen treat. More specifically, the present invention relates to an apparatus, a system and a method for collecting drips from a frozen treat on a stick with a handle extending from the frozen treat. The apparatus, the system and the method may have a tray with a cover located on a side of the tray. The cover may be a pad, such as, for example, a paper napkin, a coffee filter, a paper towel. The cover may be made from an absorbent material, such as, for example, a cotton fiber, a wood pulp fiber, a cellulose fiber, a polypropylene and/or the like. Further, the cover may be made from an adsorbent material used in diapers which may trap liquids, such as, for example, polysodium acrylate, hygroscopic chemicals and/or the like. Still further, the tray may have an opening for receiving the handle of the stick of the frozen treat. The opening may allow a user to hold the stick of the frozen treat in an upright position above the cover. Moreover, the cover may collect the drips from the frozen treat and/or may absorb the drips from the frozen treat.

It is generally known that vendors may serve frozen treats, such as, for example, ice cream, frozen yogurt, flavored ice, on a stick. A portion of the stick extends into the frozen treat, and the remainder of the stick serves as a handle for a hand of the user. The user typically holds the handle of the stick and the frozen treat in an upright position to prevent the frozen treat from separating from the stick and/or falling off of the stick. However, the frozen treat may begin to melt during consumption and/or drips may form and fall downward. The drips may land on the hand of the user and/or may cause the hand of the user to become, for example, unclean and/or sticky from the syrup-like contents of the frozen treat. The user may tilt the handle of the stick and the frozen treat to avoid having the drips fall and land on the user. However, the frozen treat may continue to melt and/or fall from the treat.

The vendor of the frozen treat on the stick generally places a divider under the frozen treat to protect the hands of the user from the falling drips as the frozen treat melts. The divider is traditionally made from a material, such as, for example, a wood fiber board, polyester, webbed paper and/or the like. The divider may catch the drips from the frozen treat. The handle of the stick may still be used as the handle of the frozen treat while the divider is being used. Additionally, during the consumption of the frozen treat, the drips on the divider may spill from onto, for example, the user or nearby surroundings. Further, the drips of the frozen treat and/or the divider may be discarded by the user after the consumption of the frozen treat.

A need, therefore, exists for an apparatus, a system and a method for collecting drips from a frozen treat. Additionally, a need exists for an apparatus, a system and a method for collecting drips from a frozen treat which may prevent the drips from falling onto the user and/or surroundings of the user. Further, a need exists for an apparatus, a system and a method for collecting drips from a frozen treat which may prevent spillage of the collected drips. Still further, a need exists for an apparatus, a system and a method for collecting drips from a frozen treat which may absorb the drips as the drips fall from the frozen treat. Moreover, a need exists for an apparatus, a system and a method for collecting drips from a frozen treat which may be disposable and/or reusable.

### SUMMARY OF THE INVENTION

The present invention generally relates to an apparatus, a system and a method used during consumption of a frozen treat. More specifically, the present invention relates to an apparatus, a system and a method for collecting drips from a frozen treat on a stick having a handle which extends outside of the frozen treat. Alternatively, the frozen treat may be a double-stick frozen treat having two handles which extend outside of the frozen treat. The apparatus, the system and the method may have a tray with a cover located on a side of the tray. The cover may be a pad, such as, for example, a paper napkin, a coffee filter, a paper towel. Further, the cover may be made from an absorbent material, such as, for example, a cotton fiber, a wood pulp fiber, a cellulose fiber, a polypropylene and/or the like. Moreover, the cover may be made from an adsorbent material used in diapers which may trap liquids, such as, for example, polysodium acrylate, hygroscopic chemicals and/or the like.

The tray may have an opening which may receive the handle of the stick. In the alternative, the tray may have an opening which may receive the two handles of the double-stick frozen treat. The handle or the two handles may be inserted into the opening until the cover is adjacent to the frozen treat. The opening may allow the user to hold the stick or the sticks of the frozen treat in an upright position located above the cover. Moreover, the cover may collect the drips from the frozen treat and/or may absorb the drips from the frozen treat. The opening may prevent the drips of the frozen treat from flowing down the handle or the two handles of the stick. Furthermore, the tray and/or the cover may prevent the spillage of the collected drips onto the user and/or the surroundings of the user.

To this end, in an embodiment of the present invention, an apparatus for collecting drips from a frozen treat is provided. The apparatus has a base defined by a perimeter wherein the base has a top layer covering a bottom layer wherein the base is planar and further wherein the top layer is an absorbent material. Further, the apparatus has a lip on the perimeter of the base wherein the lip extends outward with respect to the top layer of the base. Moreover, the apparatus has an opening in the base extending from the top layer to the bottom layer wherein the opening is located inside the perimeter of the base.

In an embodiment, the bottom layer is plastic.

In an embodiment, the absorbent material is paper.

In an embodiment, the apparatus has an adhesive sticker on the base.

In an embodiment, the apparatus has a washable tattoo on the base.

In an embodiment, the apparatus has a partition in the base wherein the partition is removed from the base.

In an embodiment, the apparatus has a mark printed on the base.

In another embodiment of the present invention, a system for collecting drips from a frozen treat mounted on a stick is provided. The system has a base defined by a perimeter wherein the base has a top side and a bottom side opposite the top side wherein the base is planar. Further, the system has a lip on the perimeter of the base wherein the lip extends outward with respect to the top side of the base. Still further, the system has an absorbing means covering the top side of the base wherein the absorbing means is located inside the perimeter of the base. Moreover, the system has a slit in the base for supporting the stick of the frozen treat in a nonparallel position with respect to the base wherein the slit is located within the perimeter of the base. Furthermore, the system has an opening in the absorbing means wherein the opening overlaps the slit in the base.

In an embodiment, the system has a sticker removable attached to the absorbing means.

In an embodiment, the system has a partition in the absorbing means wherein the partition is separable from the absorbing means.

In an embodiment, the system has a plurality of perforations partitioning the absorbing means.

In an embodiment, the system has a washable tattoo removable attached to the absorbing means.

In another embodiment of the present invention, a method for collecting drips from a frozen treat mounted on a stick is provided. The method has the step of providing a base defined by a first perimeter wherein the base has a first side and a second side opposite the first side wherein the base is planar. Additionally, the method has the step of providing a cover defined by a second perimeter wherein the cover has a first side and a second side opposite the first side wherein the second perimeter of the cover is less than the first perimeter of the base and further wherein the cover is an absorbent material. Further, the method has the step of connecting the second side of the cover to the first side of the base wherein the cover is located inside the perimeter of the tray. Still further, the method has the step of providing an opening through the cover and the base wherein the opening extends from the first side of the cover to the second side of the base and further wherein the opening is located inside the perimeter of the cover. Moreover, the method has the step of providing a lip on the perimeter of the tray wherein the lip extends outward with respect to the first side of the base.

In an embodiment, the method has the step of perforating the cover to form a partition in the cover.

In an embodiment, the method has the step of partitioning the base with a plurality of perforations.

In an embodiment, the method has the step of connecting the second side of the cover to the first side of the base.

In an embodiment, the method has the step of laminating the cover.

In an embodiment, the method has the step of inserting the stick of the frozen treat into the opening of the cover and the base.

In an embodiment, the method has the step of adhering a removable sticker to the cover.

In an embodiment, the method has the step of adhering a washable tattoo to the cover.

It is, therefore, an advantage of the present invention to provide an apparatus, a system and a method for collecting drips from a frozen treat.

Another advantage of the present invention is to provide an apparatus, a system and a method for collecting drips from a frozen treat which provides a tray to collect the drips.

And, another advantage of the present invention is to provide an apparatus, a system and a method for collecting drips from a frozen treat which provides a cover to absorb the drips.

Yet another advantage of the present invention is to provide an apparatus, a system and a method for collecting drips from a frozen treat which prevents the drips from falling onto a user and/or surroundings of the user.

A further advantage of the present invention is to provide an apparatus, a system and a method for collecting drips from a frozen treat which may absorb the drips from the frozen treat as the drips fall from the frozen treat.

Moreover, an advantage of the present invention is to provide an apparatus, a system and a method for collecting drips from a frozen treat which may be disposable after use.

And, another advantage of the present invention is to provide an apparatus, a system and a method for collecting drips from a frozen treat which provides printed indicia on the cover of the tray.

Yet another advantage of the present invention is to provide an apparatus, a system and a method for collecting drips from a frozen treat which provides lamination over the cover of the tray.

Another advantage of the present invention is to provide an apparatus, a system and a method for collecting drips from a frozen treat which provides a collectible card or disk on the cover of the tray.

Yet another advantage of the present invention is to provide an apparatus, a system and a method for collecting drips from a frozen treat which allows the cover to be separated from the tray and/or discarded.

A still further advantage of the present invention is to provide an apparatus, a system and a method for collecting drips from a frozen treat which provides removable stickers on the cover of the tray.

Moreover, an advantage of the present invention is to provide an apparatus, a system and a method for collecting drips from a frozen treat which provides washable body tattoos on the cover of the tray.

And, another advantage of the present invention is to provide an apparatus, a system and a method for collecting drips from a frozen treat which may be a double-stick frozen treat having two handles.

Yet another advantage of the present invention is to provide an apparatus, a system and a method for collecting drips from a frozen treat which provides removable game pieces.

A further advantage of the present invention is to provide an apparatus, a system and a method for collecting drips from a frozen treat which provides removable puzzle pieces.

Moreover, an advantage of the present invention is to provide an apparatus, a system and a method for collecting drips from a frozen treat which provides a removable token redeemable for a prize from an enterprise.

And, another advantage of the present invention is to provide an apparatus, a system and a method for collecting drips from a frozen treat which provides removable collectible card containing a written message.

Yet another advantage of the present invention is to provide an apparatus, a system and a method for collecting drips from a frozen treat which provides a toy for entertainment.

A still further advantage of the present invention is to provide an apparatus, a system and a method for collecting drips from a frozen treat which provides flying disk toy.

Additional features and advantages of the present invention are described in, and will be apparent from, the detailed description of the presently preferred embodiments and from the drawings.

### BRIEF DESCRIPTION OF THE DRAWINGS

FIG. 1 illustrates an exploded perspective view of an apparatus in an embodiment of the present invention.

FIG. 2 illustrates a top plan view of a base in an embodiment of the present invention.

FIG. 3 illustrates a top plan view of a base in an embodiment of the present invention.

FIG. 4 illustrates a bottom plan view of a base in an embodiment of the present invention.

FIG. 5 illustrates a bottom plan view of a base in an embodiment of the present invention.

FIG. 6 illustrates a plan view of a cover in an embodiment of the present invention.

FIG. 7 illustrates a plan view of a cover in an embodiment of the present invention.

### DETAILED DESCRIPTION OF THE PRESENTLY PREFERRED EMBODIMENTS

The present invention generally relates to an apparatus, a system and a method used during consumption of a frozen treat. More specifically, the present invention relates to an apparatus, a system and a method for collecting drips from a frozen treat on a stick with a handle which extends from the frozen treat. Alternatively, the frozen treat may be a double-stick frozen treat having two handles which may extend from the frozen treat. The apparatus, the system and the method may have a tray with a cover located on a side of the tray. Further, the tray may have an opening to receive the handle of the stick or the two handles of the double-stick frozen treat which may be inserted into the opening. Still further, the opening may prevent the drips from the frozen treat from flowing down the handle of the stick or the two handles of the double-stick frozen treat. Moreover, the cover may collect the drips from the frozen treat and/or may absorb the drips from the frozen treat.

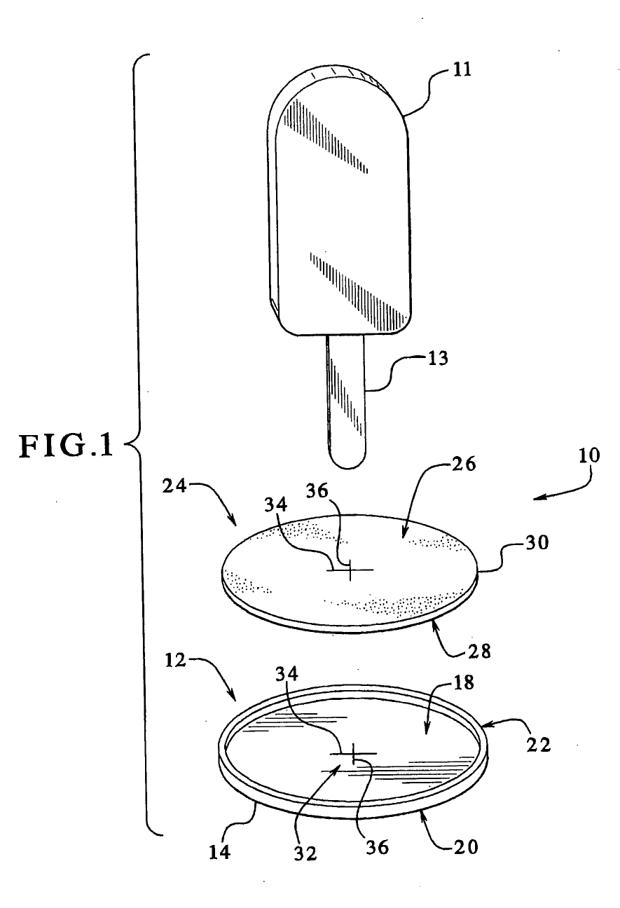

Referring now to the drawings wherein like numerals refer to like parts, FIG. 1 illustrates an apparatus 10 for collecting drips from a frozen treat 11 in an embodiment of the present invention. The frozen treat 11 may be mounted on a stick. Alternatively, the frozen treat 11 may be mounted on two sticks of the double-stick frozen treat. Further, the frozen treat 11 may be, for example, ice cream, frozen yogurt, favored ice, and/or the like. The stick may have a handle 13 which may extend from the frozen treat 11. In the alternative, the double-stick frozen treat may have two handles which extend from the frozen treat. The handle 13 or two handles may allow a user to hold the frozen treat 11 with his/her hand while consuming the frozen treat 11. Still further, the stick, the handle 13, and/or the two handles may be made from a material, such as, for example, wood, plastic and/or the like. Moreover, the present invention should not be deemed as limited to the embodiments of a specific frozen treat and/or a specific material of the stick, the handle 13 and/or the two handles of the frozen treat 11.

The apparatus 10 may have a base 12 which may be made from a material, such as, for example, cellulose fiber, plywood, plastic, polyethylene, polyurethane and/or the like. The base 12 may have a shape, such as, for example, a square, a rectangle, a circle, an oval, a triangle, a star and/or the like. Additionally, the base 12 may have a perimeter 14. Further, the base 12 may have a top side 18 and a bottom side 20 which may be opposite to the top side 18. Still further, the base 12 may have a lip 22 on the perimeter 14 of the base 12. The lip 22 may extend outward with respect to the top side 18 of the base 12. The base 12 which may be made from cellulose fiber and/or plywood may be cut with, for example, a machine press, a die cutter, a wood cutter and/or the like. A base 12 which may be made from, for example, plastic, polyethylene and/or polyurethane may be molded by a molding procedure, such as, for example, injection molding, compression molding and/or the like. Moreover, the present invention should not be deemed as limited to the embodiments of a specific shape and/or a specific length of the perimeter of the base 12. Moreover, it should be understood that the base 12 may be made by any method that may be implemented by one having ordinary skill in the art.

The base 12 may have a cover 24 attached to the base 12. The cover 24 may have a first side 26 and a second side 28 which may be opposite to the first side 26. Further, the cover 24 may have a perimeter 30. The cover 24 may be a pad, such as, for example, a paper napkin, a coffee filter, a paper towel. Still further, the cover 24 may be made from an absorbent material, such as, for example, a cotton fiber, a wood pulp fiber, a cellulose fiber, a polypropylene and/or the like. The cover 24 may be made from an adsorbent material used in diapers which may trap liquids, such as, for example, polysodium acrylate, hygroscopic chemicals and/or the like. The second side 28 of the cover 24 may cover to the top side 18 of the base 12. The cover 24 may be placed over the top side 18 of the base 12. Alternatively, the second side 28 of the cover 24 may be connected to the top side 18 of the base 12 with an adhesive, such as, for example, an epoxy, a glue, a gum, a paste and/or the like. Moreover, the perimeter 30 of the cover 24 may be less than the perimeter 14 of the base 12. When the second side 28 of the cover 24 is attached to the top side 18 of the base 12, the perimeter 30 of the cover 24 may be located within the perimeter 14 and the lip 22 of the base 12. The cover 24 may have the same shape and/or a similar shape of the base 12, such as, for example, a square, a rectangle, a circle, an oval, a triangle, a star and/or the like. It should be understood that the cover 24 may have any shape so long as the cover 24 may be located within the perimeter 14 of the base 12. The present invention should not be deemed as limited to the embodiments of a specific absorbent material, a specific adhesive and/or a specific length of the perimeter 14 of the cover 24.

As further illustrated in FIG. 1, the base 12 and the cover 24 may have an opening 32 which may allow for passage of the handle 13 of the frozen treat 11. Alternatively, the opening may allow for passage of the two handles of the double-stick frozen treat. Further, the opening 32 may be formed by a first slit 34 and a second slit 36 which may be perpendicular to the first slit 34. Still further, the opening 32 may be formed by a single slit. The opening 32 may allow the handle 13 or the two handles of the double-stick frozen treat to pass from the first side 26 of the cover 24 to the bottom side 20 of the base 12. The opening 32, the first slit 34 and the second slit 36 and/or the single slit may be cut into the base 12 and/or the cover 24 by, for example, a machine press, a punch machine, a die cutter, a manual cutter and/or the like. The opening 32, the first slit 34 and the second slit 36 and/or the single slit may be formed in the base 12 by a molding procedure, such as, for example, injection molding, compression molding and/or the like. Moreover, the present invention should not be deemed as limited to the embodiments of a specific method for cutting and/or forming the opening 32, the first slit 34 and the second slit 36 and/or the single slit in the base 12 and/or the cover 24. It should be understood that the opening 32, the first slit 34 and the second slit 36 and/or the single slit may be cut and/or formed in the base 12 and/or the cover 24 by any method that may be implemented by one having ordinary skill in the art.

In an alternative embodiments the opening 32 of the cover 24 may have a perimeter which may be less than the perimeter 30 of the cover 24. Further, the opening 32 of the cover 24 may allow the handle 13 or the two handles of the double-stick frozen treat to pass from the first side 26 of the cover 24 to the bottom side 20 of the base 12 without contacting the cover 24. Still further, the opening 32 in the cover 24 may have the same shape and/or a similar shape as the cover 24, such as, for example, a square, a rectangle, a circle, an oval, a triangle, a star and/or the like. It should be understood that the opening 32 of the cover 24 may have any shape so long as the opening 32 may be located within the perimeter 30 of the cover 24. The present invention should not be deemed as limited to the embodiments of a specific shape and/or a specific length of the perimeter of the opening 32 of the cover 24.

The handle 13 of the frozen treat 11 or the two handles of the double-stick frozen treat may be inserted through the opening 32 until the frozen treat 11 abuts and/or is adjacent to the first side 26 of the cover 24. Further, the handle 13 or the two handles inserted through the opening 32 may extend outward with respect to the bottom side 20 of the base 12 and/or may be held by his/her hand of the user. Thereafter, the user may hold the handle 13 of the frozen treat 11 or the two handles of the double-stick frozen treat in an upright position wherein the cover 24 and the base 12 may be located between the frozen treat 11 and the hand of the user. By holding the handle 13 or the two handles of the double-stick frozen treat in the upright position, the cover 24 of the base 12 may be located adjacent to the frozen treat 11 and/or may be located below the frozen treat 11. During consumption of the frozen treat 11 by the user, the frozen treat 11 may begin to melt and/or may begin to change from a solid state to a liquid state wherein drips may form on the frozen treat 11 and fall downward with respect to the frozen treat 11.

The cover 24 located below the frozen treat 11 may catch the drips which may fall from the frozen treat 11 as the frozen treat 11 melts. The drips from the frozen treat may be absorbed by the cover 24 and/or may be collected within the cover 24. Further, the cover 24 may become moist and/or wet from the drips which may have been absorbed by the cover 24. Still further, the drips may collect and/or may form pools on the top side 18 of the base 12. The top side 18 of the base 12 may support the moist and/or wet cover 24 and/or the bottom side 16 of the base 14 which may protect the hand of the user from the moist and/or the wet cover 24. The base 12 and/or the cover 24 may protect the hand of the user and/or surroundings of the user from the drips which may fall from the frozen treat 11.

The opening 32 of the cover 24 and/or the base 12 may prevent drips of the frozen treat 11 from flowing down the stick of the frozen treat 11 to the handle 13. In an alternative embodiment, an opening of the cover 24 and/or the base 12 may prevent drips of the double-stick frozen treat from flowing down the two sticks to the two handles of the double-stick frozen treat. Further, the single slit and/or the first slit 34 and the second slit 36 of the cover 24 and/or the base 12 may allow the handle 13 to pass through the opening 32. The first slit 34 and the second slit 36 of the base 12 may maintain a seal around the handle 13 which may prevent the drips from passing from the top side 18 of the base 12 to the bottom side 20 of the base 12. In the alternative, the first slit 34 and the second slit 36 of the base 12 may maintain a seal around the two handles of the double-stick frozen treat which may prevent the drips from passing from the top side 18 of the base 12 to the bottom side 20 of the base 12. Still further, the opening 32 of the base 12 may prevent the drips absorbed in the cover 24 and/or pooled on the top side 18 of the base 12 from leaking onto the handle 13. Moreover, the opening 32 may protect the hand of the user and/or the surroundings of the user from drips of the frozen treat 11 or the double-stick frozen treat.

The lip 22 of the base 12 may prevent the perimeter 30 of the cover 24 from extending beyond the perimeter 14 of the base 12. The cover 24 which may absorb the drips from the frozen treat 11 or the double-stick frozen treat may not expand beyond the lip 22 of the base 12. Further, the lip 22 may prevent the drips which have pooled on the top side 18 of the base 12 from flowing beyond the perimeter 14 of the base 12. Moreover, the lip 22 may serve as a barrier to keep the drips on the top side 18 of the base 22. Moreover, the lip 22 may protect the hand of the user and/or the surroundings of the user from the drips of the frozen treat 11.

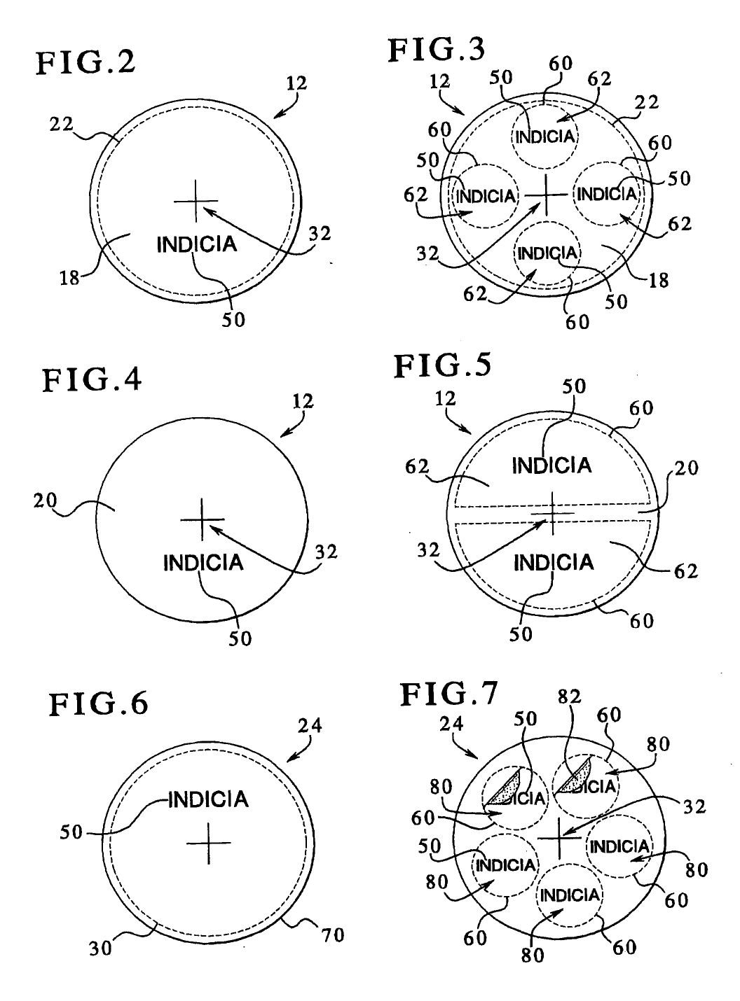

As illustrated in FIG. 2 and FIG. 4, the top side 18 of the base 12 and/or the bottom side 20 of the base 12 may display indicia 50, respectively. FIG. 6 illustrates that the indicia 50 may be displayed on either side of the cover 24. Further, the indicia 50 may be marks, such as, for example, numerals, numerical sequences, designs, insignias, language characters, images, cartoons, bar codes and/or the like. Still further, the marks may relate to a topic, such as, for example, a cartoon character, an athlete, a musical performer, a political figure, a redemption code, a game board, a jigsaw puzzle, a visual scene, a competition, a prize, a promotional contest, a written message, a theme and/or the like. Moreover, the indicia 50 may relate to an entity, for example, an entertainment company, a food manufacturing company, a bottling company, a food processing company and/or the like. Further, the present invention should not be deemed as limited to the embodiments of specific marks, specific topics and/or specific entities of the indicia 50.

The indicia 50 may be, for example, screened and/or stamped onto the first side 26 of the cover 24, the second side 28 of the cover 24, the first side 18 of the base 12 and/or the bottom side 20 of the base 12. Further, the indicia 50 may be, for example, printed onto the first side 26 and/or the second side 28 of the cover 24 by, for example, a laser printer, a dot-matrix printer and/or the like. Still further, the base 12, the top side 18 of the base 12 and/or the bottom side 20 of the base 12 may be molded to contain and/or to display the indicia 50 by a molding procedure, such as, for example, injection molding, compression molding and/or the like. Further, the present invention should not be deemed as limited to the embodiments of a specific method for placing the indicia 50 on the first side 26 of the cover 24, the second side 28 of the cover 24, the top side 18 of the base 12 and/or the bottom side 20 of the base 12. Moreover, it should be understood that the indicia 50 may be placed on the first side 26 of the cover 24, the second side 28 of the cover 24, the first side 18 of the base 12 and/or the bottom side 20 of the base 12 by any method that may be implemented by one having ordinary skill in the art.

As illustrated in FIG. 3 and FIG. 5, the first side 18 of the base 12 and/or the bottom side 20 of the base 12 may have perforations 60, respectively. The perforations 60 may extend from the first side 18 to the second side 20 of the base. FIG. 7 illustrates that either side of the cover 24 may have perforations 70 which may extend from the top side 26 to the bottom side 28 of the cover 24. The perforations 60 may form one or more partitions 62 which may be located inside the perforations 60. Further, the partitions 62 may be located within the perimeter 30 of the cover 24 and/or the perimeter 14 of the base 12. The perforations 60 and the partitions 62 may be in a pattern and/or a shape, such as, for example, a row, a circle, a box, a triangle and/or the like. The perforations 60 may form any number of partitions 62, such as, for example, one, two (as shown in FIG. 5), four (as shown in FIG. 3), five, ten, twelve, and/or the like.

The partitions 62 may create “pop-outs” which may contain, for example, the indicia 50. Further, the user may apply force along the perforations 60 to separate the “pop-outs” from the base 12 and/or the cover 24. The perforations 60 may be, for example, formed in the cover 24 and/or the base 12 by, for example, a machine press, a punch machine, a die cutter and/or the like. Still further, the “pop-outs” may be removable pieces, such as, for example, a game piece which may related to the game board, a puzzle piece which may related to the jigsaw puzzle and/or the visual scene, a token which may related to the promotional contest, a collectible card which may contain the written message and/or the like. Alternatively, the indicia 50 may be the redemption code which may be redeemed by the entity for a prize and/or a product related to the entity. The present invention should not be deemed as limited to the embodiments of a specific pattern and/or shape of the perforations 60 and the partitions 62 on the cover 24, specific removable pieces of the “pop-outs” and/or a specific number of partitions 62. Moreover, it should be understood that the perforations 60 and/or partitions 62 may be bored into the cover 24 and/or the base 12 by any method that may be implemented by one having ordinary skill in the art.

As further illustrated in FIG. 7, the cover 24 may have the perforations 60 which may form one or more transferable images 80. The transferable images 80 may be located inside the perforations 60. Further, the transferable images may be located within the perimeter 30 of the cover 24. The perforations 60 and the transferable images 80 may be in a pattern and/or a shape, such as, for example, a row, a circle, a box, a triangle and/or the like. The cover 24 may contain any number of transferable images 80, such as, for example, one, two three, four, five (as shown in FIG. 7), six, eleven, and/or the like. The perforations 60 of the cover 24 may form one or more of the “pop-outs” which may be the removable pieces containing the indicia 50. Moreover, the present invention should not be deemed as limited to the embodiments of a specific pattern and/or shape of the perforations 60 and the transferable images 80 on the cover 24, a specific number of transferable images 80, a specific number of “pop-outs”, a specific number of removable pieces and/or specific indicia.

The transferable images 80 may be, for example, adhesive stickers, washable tattoos and/or the like. The transferable images 80 may contain the indicia 50. The transferable images 80 may have first sides displaying the indicia 50 and adhesive sides 82 opposite to the first sides which affix the transferable images 80 to the cover 24 within the perforations 60. Further, the user may apply force along the perforations 60 to separate the adhesive sides 82 of the transferable images 80 from the cover 24 and/or to separate the “pop-outs” which contain the removable pieces from the cover 24. After removing the transferable images 80, the user may utilize the transferable images 80 by, for example, adhering the transferable images 80 to surfaces and/or transferring the indicia 50 of the transferable images 80 to the surfaces. Moreover, it should be understood that the transferable images 80 may be affixed into the cover 24 and/or may be utilized by the user by any method that may be implemented by one having ordinary skill in the art.

A protective layer 70 may be applied to the cover 24 and/or may cover the cover 24, the first side 26 of the cover 24 and/or the second side 28 of the cover 24. The protective layer 70 may be made with a laminating material, such as, for example, an orthophthalic polyester resin and/or the like. The protective layer 70 may be, for example, a clear transparent material. The laminating surface may have adhesive qualities. Further, the lamination may secure the cover 24 to the top side 18 of the base with, for example, the adhesive qualities, or the like. The cover 24 having the protective layer 70 may contain the perforations 60, the partitions 62, the “pop-outs” and/or the removable pieces. The cover 24 having the protective layer 70 and the indicia 50 may be, for example, a collectible card and/or the like. Still further, the present invention should not be deemed as limited to the embodiments of a specific protective layer 70. Moreover, it should be understood that the protective layer 70 may be applied to the cover 24 by any method that may be implemented by one having ordinary skill in the art.

After the user consumes frozen treat 11 and/or the user no longer wants the frozen treat 11, the apparatus 10 and/or the frozen treat 11 may be discarded by the user into, for example, a waste receptacle and/or the like. Alternatively, the cover 24 may be separated from the base 12 by the user. The user may apply force to the cover 24 to remove the cover 24 from the first side 18 of the base 12. Thereafter, the user may discard the used cover 24 and/or sanitize the base 12 with, for example, a soap and water for additional uses. Moreover, a new cover 24 may be placed on the base 12 and/or may cover the top side 18 of the base 24 and/or a stick of a new frozen treat 11 may be inserted into the opening 32. In the alternative embodiment, a new cover 24 may be placed on the base 12 and/or may cover the top side 18 of the base 24 and/or two sticks of a double-stick frozen treat maybe inserted into the opening.

In an alternative embodiment, the apparatus 10 may be used as a toy. After the cover 24 has been removed from the base 12, the base 12 may be used as an entertainment toy by a person, such as, for example, children, teenagers and/or the like. Further, the toy may be a throwing toy, such as, for example, a flying disk by the person. When used as a flying disk, the base 12 and/or the lip 22 may be made from a heavy-duty polymer, such as, for example, plastic, polyethylene, polyurethane, rubber and/or the like. Moreover, the base 12 may be molded by a molding procedure, such as, for example, injection molding, compression molding and/or the like. Furthermore, the present invention should not be deemed as limited to the embodiments of a specific entertainment toy, a specific flying disk and/or a specific heavy-duty polymer. Moreover, it should be understood that the base 12 may be made by any method that may be implemented by one having ordinary skill in the art.

The apparatus 10 may be used by a user during consumption of the frozen treat 11 on the stick or the two sticks of the double-stick frozen treat. The apparatus 10 may have a base 12 with a cover 24 to collect the drips from the frozen treat 11. Further, the apparatus 10 may have an opening 32 which may receive the handle 13 of the frozen treat 11 or the two handles of the double-stick frozen treat. The handle 13 or the two handles may be inserted into the opening 32 until cover 24 is adjacent to the frozen treat 11. Still further, the opening 32 may allow the user to hold the handle 13 or the two handles of the frozen treat 11 in an upright position above the cover 24. Additionally, the opening 32 may prevent the drips of the frozen treat 11 from flowing down the handle 13 or the two handles. Moreover, the cover 24 may collect the drips from the frozen treat 11 and/or may absorb the drips from the frozen treat 11.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

1. An apparatus for collecting drips from a frozen treat, the apparatus comprising:
a base defined by a perimeter wherein the base has a top layer covering a bottom layer wherein the base is planar and further wherein the top layer is an absorbent material;
a lip on the perimeter of the base wherein the lip extends outward with respect to the top layer of the base; and
an opening in the base extending from the top layer to the bottom layer wherein the opening is located inside the perimeter of the base.

2. The apparatus of claim 1 wherein the bottom layer is plastic.

3. The apparatus of claim 1 wherein the absorbent material is paper.

4. The apparatus of claim 1 further comprising:
an adhesive sticker on the base.

5. The apparatus of claim 1 further comprising:
a washable tattoo on the base.

6. The apparatus of claim 1 further comprising:
a partition in the base wherein the partition is removed from the base.

7. The apparatus of claim 1 further comprising:
a mark printed on the base.

8. A system for collecting drips from a frozen treat mounted on a stick, the system comprising:
a base defined by a perimeter wherein the base has a top side and a bottom side opposite the top side wherein the base is planar;
a lip on the perimeter of the base wherein the lip extends outward with respect to the top side of the base;
an absorbing means covering the top side of the base wherein the absorbing means is located inside the perimeter of the base;
a slit in the base for supporting the stick of the frozen treat in a nonparallel position with respect to the base wherein the slit is located within the perimeter of the base; and
an opening in the absorbing means wherein the opening overlaps the slit in the base.

9. The apparatus of claim 8 further comprising:
a sticker removable attached to the absorbing means.

10. The apparatus of claim 8 further comprising:
a partition in the absorbing means wherein the partition is separable from the absorbing means.

11. The apparatus of claim 8 further comprising:
a plurality of perforations partitioning the absorbing means.

12. The apparatus of claim 8 further comprising:
a washable tattoo removably attached to the absorbing means.

13. A method for collecting drips from a frozen treat mounted on a stick, the method comprising of the steps:
providing a base defined by a first perimeter wherein the base has a first side and a second side opposite the first side wherein the base is planar;
providing a cover defined by a second perimeter wherein the cover has a first side and a second side opposite the first side wherein the second perimeter of the cover is less than the first perimeter of the base and further wherein the cover is an absorbent material;
connecting the second side of the cover to the first side of the base wherein the cover is located inside the perimeter of the tray;
providing an opening through the cover and the base wherein the opening extends from the first side of the cover to the second side of the base and further wherein the opening is located inside the perimeter of the cover; and
providing a lip on the perimeter of the tray wherein the lip extends outward with respect to the first side of the base.

14. The method of claim 13 further comprising of the step:
perforating the cover to form a partition in the cover.

15. The method of claim 13 further comprising the step of:
partitioning the base with a plurality of perforations.

16. The method of claim 13 further comprising the step of:
connecting the second side of the cover to the first side of the base.

17. The method of claim 13 further comprising the step of:
laminating the cover.

18. The method of claim 13 further comprising the step of:
inserting the stick of the frozen treat into the opening of the cover and the base.

19. The method of claim 13 further comprising the step of:
removing the cover from the base to form a disk.

20. The method of claim 13 further comprising the step of:
utilizing the base as a disk wherein the base is separated from the cover.
